(19) United States
(12) Patent Application Publication
(10) Pub. No.: US 2022/0388905 A1
(43) Pub. Date: Dec. 8, 2022

(54) READY-MIXED DRYING-TYPE JOINT COMPOUNDS CONTAINING pH BUFFER SYSTEMS

(71) Applicant: UNITED STATES GYPSUM COMPANY, Chicago, IL (US)

(72) Inventors: Scott D. CIMAGLIO, Grayslake, IL (US); Renee WEINBERGER, Waukegan, IL (US)

(73) Assignee: UNITED STATES GYPSUM COMPANY, Chicago, IL (US)

(21) Appl. No.: 17/663,006

(22) Filed: May 11, 2022

Related U.S. Application Data
(60) Provisional application No. 63/196,888, filed on Jun. 4, 2021.

(51) Int. Cl. C04B 28/00; C04B 14/28; C04B 14/18; C04B 24/38; C04B 24/26; C04B 22/10; C04B 22/06; C04B 22/16

(52) U.S. Cl. CPC C04B 28/001; C04B 14/28; C04B 14/18; C04B 24/383; C04B 24/2623; C04B 22/106; C04B 22/064; C04B 22/16; C04B 2111/00681

(57) ABSTRACT

The present invention is a ready-mixed, drying-type joint compound including an alkali sensitive component and a pH buffer system of a weak acid and its conjugate base to maintain pH of 8-12, typically for 120 days or more at 75° F. in a sealed container.

### RELATED APPLICATION

The present application claims priority to U.S. Provisional Application No. 63/196,888 filed on Jun. 4, 2021, hereby incorporated by reference.

### FIELD OF THE INVENTION

This invention relates generally to ready-mixed drying-type joint compounds comprising a pH buffer system of a weak acid and its conjugate base to maintain a pH of 8-12, preferably 9-11, for a significant length of time, typically 120 days or more.

### BACKGROUND OF THE INVENTION

In the construction of buildings, one of the most common building elements is gypsum wallboard, often known as drywall or gypsum paneling, used in the construction of walls and/or ceilings. The board may be composed of any of a variety of materials, including but not limited to, cementitious materials such as, for example, cement or gypsum. Walls made from gypsum wallboard are traditionally constructed by affixing the panels to wood studs or metal framing, and treating the joints between adjoining panels with a specially prepared adhesive called a joint compound. Gypsum panels easily accommodate walls that are unusual in size and can be shaped around structural elements such as beams or pipes. The side edges of the drywall panels are tapered, thus allowing the joint compound to be applied to the seam, between adjoining panels, in such a way that a monolithic surface is created when finished.

Ready mixed, drying-type joint compounds (referred to as “joint compounds” or “ready-mixed joint compounds” in this specification) are pre-mixed with water during manufacturing and require little or no addition of water at the job site. Drying-type joint compositions can also be dry powders that are mixed with water at the job site. Drying-type joint compounds harden when the water evaporates and the compound dries. Drying-type joint compounds substantially contain a filler component. Prior to use (generally during manufacturing), the filler, a binder, a thickener, optionally a dedusting agent, and optionally several other ingredients are mixed for a specific time with water to produce the drying-type joint compound. In the case of ready-mixed compounds, water and other liquid additives are added during manufacture. Such a composition has a high ionic content and basic pH. Once the drying-type joint compound is applied to the wallboard panels, the composition dries (i.e., water evaporates) and a dry, relatively hard cementitious material remains.

U.S. Pat. No. 4,853,085 (incorporated herein by reference) to United States Gypsum Company teaches buffer systems used in gypsum wallboard in an amount from about 0.25 to about 10%, capable of maintaining the pH of the paper stock at a value of at least 7 and preferably 7 to 7.8. The buffer material may be any of a number of compounds which are salts of a cation of a strong base and an anion of a weak acid. Although a number of materials may be utilized such as sodium carbonate and sodium bicarbonate. The preferred filler is calcium carbonate.

U.S. Pat. No. 7,066,996 to Hercules Incorporated discloses ready-mixed joint compounds that have pH modifiers to increase the alkalinity of the composition to achieve the desired pH values of 8 to 10. U.S. Pat. No. 7,066,996 to Hercules Incorporated also discloses that depending on local preferences, other ingredients may be used in the joint compound formulation. These include air entraining agents, surfactants, humectants, pH buffering salts, and defoamers.

US Patent Application Publication No. 2005/0020743 to Ruhlmann teaches buffer-effect dispersants for paint bases and pigmentary compositions comprising the combination of a partially or totally neutralized water-soluble dispersing agent which is a homopolymer of acrylic or methacrylic acid with at least one other unsaturated ethylenic monomer with a compound having specific buffer properties.

Typically oxides and hydroxides of group IA, IIA metals in the periodic table, or ammonia/ammonium compounds and/or certain salts of weak acids are used to adjust pH in joint compounds. The pH is raised initially, over a very brief span of time, relative to the shelf life of such joint compound. However, the pH of the joint compounds stabilized with the metal hydroxides drops and reaches a steady state below the target pH. Many additives used in ready-mixed joint compounds are pH sensitive.

### SUMMARY OF THE INVENTION

This invention relates generally to ready-mixed, drying-type joint compounds comprising an alkali sensitive component and comprising a pH buffer system to impart a stable pH. The invention may maintain the pH of the ready-mixed, drying-type joint compounds in a range having a lower limit of pH of 8 or 9. The invention may maintain the pH of the ready-mixed, drying-type joint compounds in a range having an upper limit of pH of 11 or 12. Typically the invention maintains the pH of the ready-mixed, drying-type joint compounds in a range of 8-12, more preferably 9-11.

The invention provides a more cost effective and better performing joint compound, which incorporates components, typically additives, which are “alkali sensitive” (also known as “alkali activated/dependent”). For purposes of this disclosure, a component of a joint compound that is “alkali sensitive” (also known as “activated/dependent”) is a component that requires an alkaline pH (pH above 7, or typically a pH of 8 to 12, preferably 9 to 11) to function optimally for its intended purpose. Components such as rheology modifiers (including but not limited to cellulosics (for example hydroxyethyl cellulose, hydroxy propyl methyl cellulose), acrylics, clays (for example bentonites, kaolites), binders, some preservatives (for example triazine) and many mineral additives can be alkali sensitive and require a pH above 7 to perform optimally. At lower pH, the effectiveness of alkali sensitive components can drop. This results in sub-optimal usage rates for these materials with potential cost and ecological impacts. For example, an alkali sensitive rheology modifier would not maintain the targeted viscosity when pH falls below an alkaline pH. The pH drift both up and down is minimized with a buffer system.

Providing a stable alkali pH, for example at or about 10, ensures proper activation and effectiveness of the alkali sensitive components. Employing pH buffer system in the product at the point of manufacture ensures a stable alkali pH and, as a result, helps to ensure consistent product performance over the shelf life of the ready-mixed joint compound.

The use of the pH buffer system may also result in the need for less biocide (for example, fungicides, bactericides) in a joint compound than in a joint compound without a pH buffer system.

Selection of the buffer can be made by selecting a weak acid with a Log P function of the acid dissociation constant (Ka) at or near the target pH for the joint compound. The preferred buffer system includes a weak acid and its conjugate base and function due to the counter ion effect or Le Chatelier's principle.

The joint compound may be a ready-mixed drying-type joint compound comprising a mixture of joint compound components and water; the joint compound components comprise:

a filler at about 50 wt. % to about 98 wt. % (preferably about 50 wt. % to about 93 wt. %, more preferably about 65 wt. % to about 93 wt. %) of the joint compound on a dry basis;

a binder at up to about 15 wt. % of the joint compound on a dry basis;

a polymeric thickener at up to about 3 wt. % of the joint compound on a dry basis;

a pH buffer system comprising a weak acid and a conjugate base of the weak acid, preferably at about 0.01 to about 1.0 wt. %, at about 0.01 wt. to about 0.25 wt. %, at about 0.025 to about 0.5 wt. %, typically about 0.025 to about 0.15 wt. %, at about 0.05 to about 0.25 wt. %, more typically about 0.05 to about 0.10 wt. %, of the joint compound on a dry basis; and

an additive up to about 10 wt. % of the joint compound on a dry basis, wherein optionally the additive comprises an accelerator and/or a rheology modifier;

wherein weight ratio of the water to the dry joint compound components is about 1:6 to about 3:1,

wherein at least one of the joint compound components is alkali sensitive.

The joint compound of the invention may be used by being applied to boards, joint tape, and/or another layer of the joint compound.

The joint compound of the invention may be made by combining the calcium dihydrate, the filler (if present), the binder, the polymeric thickener, the pH buffer system, and the other additives.

A preferred method of evaluating the stability of the pH of the ready-mixed, drying-type joint compound exposes the joint compound in a tightly sealed container to 75° F. when the joint compound is prepared and/or manufactured and placed in the sealed container. The container is periodically opened for a pH measurement and then resealed and maintained at 75° F. Relative humidity is not relevant because the container is sealed and therefore the joint compound will reach equilibrium in the container. Advantageously, the joint compound of the invention can maintain a pH of 8-12, preferably 9-11, when kept for 14 days or more at 75° F. in a sealed container under this pH stability evaluation method. Typically, the joint compound of the invention can maintain the pH of 8-12, preferably 9-11, when kept for 90 days or more at 75° F. in the sealed container under this pH stability evaluation method. More typically, the joint compound of the invention can maintain the pH of 8-12, preferably 9-11, when kept for 120 days or more at 75° F. in the sealed container under this pH stability evaluation method.

In the present description the term “dry basis” means a water-free basis and the term “wet basis” means a water-inclusive basis.

Other advantages, benefits and aspects of the invention are discussed below, are illustrated in the accompanying figures, and will be understood by those of skill in the art from the more detailed disclosure below. All percentages, ratios and proportions herein are by weight, unless otherwise specified.

As used in the present specification at the very least, and not as an attempt to limit the application of the doctrine of equivalents to the scope of the claim, each numerical parameter modified by the term “about” should at least be construed in light of the number of reported significant digits and by applying ordinary rounding techniques.

### BRIEF DESCRIPTION OF THE DRAWINGS

FIG. 1 is a plot showing pH of buffered coatings.

### DETAILED DESCRIPTION OF THE INVENTION

All percentages and ratios used herein, unless otherwise specified, are by weight (i.e., wt. % as denoted as % (wt/wt)) unless otherwise indicated.

The present invention provides ready-mixed, drying-type joint compounds comprising a pH buffer system comprising a weak acid and a conjugate base of the weak acid, (sometimes also listed as a conjugate base of a weak acid and the weak acid) for example: sodium carbonate and sodium bicarbonate, tribasic phosphate and dibasic phosphate, or ammonium chloride and ammonium hydroxide, preferably at about 0.01 to about 1.0 wt. %, at about 0.01 wt. to about 0.25 wt. %, at about 0.025 to about 0.5 wt. %, typically about 0.025 to about 0.15 wt. %, at about 0.05 to about 0.25 wt. %, typically about 0.05 to about 0.10 wt. %, more typically 0.05 wt. % to 0.15 wt. %, wherein at least one of the components of the joint compound is alkali sensitive and the joint compound has a pH of 8-12, preferably 9-11, for example 9.5-10.5, for 14 days or more, typically 90 days or more, more typically 120 days or more, at 75° F. in a sealed container. The pH buffer systems around 9.5-11.5 may be a weak acid and a conjugate base of (for example): carbonates, borates, 2-amino-2-methyl-1-propanol (“AMP”), glycine, ammonia, methylamine, piperazine, phosphate and piperidine.

Without being limited to mechanism, a pH buffer system, using a weak acid as well as the conjugate base of the weak acid, offers greater pH stability due to le Chatelier's principle or the counterion effect. Common buffer systems in or about the pH range of 9.5-10.5 include carbonate/bicarbonate buffers and tribasic phosphate/dibasic phosphate buffers.

The contemplated buffer system, or any other buffer system can be incorporated into a ready-mixed, drying-type joint compound to impart a stable pH. Selection of the buffer can be made by selecting a weak acid with a Log P function of the acid dissociation constant (Ka) at or near the target pH for the joint compound. The preferred buffer system includes a weak acid and its conjugate base.

The joint compound may be a ready-mixed drying type joint compound comprising a mixture of joint compound components and water, the joint compound components comprising:

calcium carbonate and/or calcium sulfate dehydrate at about 20 weight percent (wt. %) to about 98 wt. % of the joint compound on a dry basis,

a binder at up to about 15 wt. % of the joint compound on a dry basis;

a polymeric thickener at up to about 3 wt. % of the joint compound on a dry basis;

a pH buffer system comprising a weak acid and a conjugate base of the weak acid, preferably at 0.2-1.0 wt. % of the joint compound on a dry basis; and

other additives up to about 10 wt. % of the joint compound on a dry basis, wherein optionally the additive comprises an accelerator and/or a rheology modifier;

wherein weight ratio of the water to the dry joint compound components is about 1:6 to about 3:1,

wherein at least one of the joint compound components is alkali sensitive.

The joint compound may be a ready-mixed drying-type joint compound comprising a mixture of joint compound components and water; the joint compound components comprise:

a filler at about 50 wt. % to about 93 wt. % of the joint compound on a dry basis;

a binder at up to about 8 wt. % of the joint compound on a dry basis;

a polymeric thickener at up to about 2 wt. % of the joint compound on a dry basis;

a pH buffer system comprising a weak acid and a conjugate base of the weak acid, at about 0.025 wt. to about 0.15 wt. % of the joint compound on a dry basis; and

an additive up to about 10 wt. % of the joint compound on a dry basis, wherein optionally the additive comprises an accelerator and/or a rheology modifier;

wherein weight ratio of the water to the dry joint compound components is about 1:6 to about 3:1,

wherein at least one of the joint compound components is alkali sensitive.

The joint compound may be a ready-mixed drying-type joint compound comprising a mixture of joint compound components and water;

the joint compound components comprise:

a filler at about 65 wt. % to about 93 wt. % of the joint compound on a dry basis;

a binder at up to about 4 wt. % of the joint compound on a dry basis;

a polymeric thickener at about 0.1 wt. % to about 2 wt. % of the joint compound on a dry basis;

a pH buffer system comprising a weak acid and a conjugate base of the weak acid, at about 0.05 wt. to about 0.10 wt. % of the joint compound on a dry basis; and

an additive about 0.1 to about 10 wt. % of the joint compound on a dry basis, wherein optionally the additive comprises an accelerator and/or a rheology modifier;

wherein weight ratio of the water to the dry joint compound components is about 1:3 to about 1:1, more preferably about 1:3 to about 2:1,

wherein at least one of the joint compound components is alkali sensitive.

As mentioned above, advantageously the joint compounds of the invention can maintain a pH of 8-12, preferably 9-11, for example 9.5-10.5, when kept for 14 days or more, typically 90 days or more, more typically 120 days or more, at 75° F. in a sealed container.

pH Testing

The pH of a joint compound can be easily tested with a two or three-point calibrated hydronium ion-selective electrode with meter. The pH of the material is determined when a stable reading on the pH meter is achieved. The following steps are followed:
Calibrate the pH meter daily. Ensure calibration includes the expected pH range of the test material and calibration is completed with pH standards covering the tested pH range.
Prepare the material to be tested following customer practice and/or manufacturer's recommendations.
Rinse and dry the calibrated ion-selective electrode and insert into the compound following electrode/meter recommendations provided by the equipment manufacturer.
Low-viscosity materials, such as paints, can be tested by immersion of the electrode into the test sample which is under slow, constant mixing (for example with a magnetic stir bar).
High-viscosity materials, such a joint compounds, can be tested by immersion of the electrode into the test sample and the electrode is used to gently stir the material to provide a slow, constant flow of material for the electrode.
Record the sample reading and rinse and dry electrode before the next sample reading.

The pH may also tested as set forth in ISO 19396-2 Determination of pH Value.

Table 1 provides examples of the ready-mixed, drying-type joint compound formulations of the present invention. Typically values in a single column of the table are used together. However, a value for a component from a column can be substituted for a value of that component in another column where mathematically permitted.

TABLE 1
Ready-mixed, drying-type joint compound formulations

| | | | Most |
|---|---|---|---|
| | Useable | Preferred | Preferred |
| Component | range | range | Range |
| Filler (wt. % on a dry basis) | about 50- | about 50- | about 65- |
| | about 98 | about 93 | about 93 |
| Binder (wt. % on a dry basis) | up to about 15 | up to about 8 | up to about 4 |
| Polymeric Thickener (wt. % on a | up to about 3 | up to about 2 | about 0.1 to |
| dry basis) | | | about 2 |
| pH buffer system (wt. % on a dry | 0.01-1.0 | 0.025-0.5 | 0.05-0.25 |
| basis) | | | |
| Other Additives (wt. % on a dry | up to about 10 | up to about 10 | about 0.1 to |
| basis) | | | about 10 |
| Water (weight ratio of water to | about 1:6 to | about 1:6 to | about 1:3 to |
| joint compound components) | about 3:1 | about 3:1 | about 1:1 |

The joint compound of the invention may be used by being applied to boards, joint tape, and/or another layer of the joint compound.

The joint compound of the invention may be made by combining the calcium dihydrate, the filler (if present), the binder, the polymeric thickener, the pH buffer system, and the other additives.

pH Buffer System

The pH buffer system comprises a weak acid and a conjugate base of the weak acid, preferably at about 0.01 to about 0.25 wt. %, typically about 0.025 to about 0.15 wt. %, more typically about 0.05 to about 0.10 wt. %, of the joint compound on a dry basis. The pH buffer system maintains the joint compound at a pH of 8-12, preferably 9-11. Embodiments of pH buffer systems include but are not limited to a tribasic phosphate and dibasic phosphate, such as sodium phosphate dibasic (Na₂HPO₄) and sodium phosphate tribasic (Na₃PO₄) or potassium phosphate dibasic (K₂HPO₄) and potassium phosphate tribasic (K₃PO₄), or sodium carbonate and sodium bicarbonate. Another potential buffer pair is ammonia and ammonium chloride. The preferred pH buffer system comprises sodium carbonate and sodium bicarbonate.

Fillers

The joint compounds of the invention include a filler. Examples of fillers for joint compounds of the invention include, but are not limited to, calcium carbonate (or limestone), calcium sulfate dihydrate, talc, glass micro bubbles, mica, perlite, pyrophyllite, silica, calcium sulfate anhydrite, diatomaceous earth, clay (e.g., attapulgite, sepiolite and kaolin), resin microspheres, and mixtures thereof.

Drying-type (DT) joint compounds preferably include a primary DT filler and optionally a secondary DT filler. Examples of primary DT fillers include calcium carbonate, calcium sulfate dihydrate, talc, and mixtures thereof.

The primary DT filler can preferably be included at about 50 wt. % to about 98 wt. % on a dry basis of the joint compound, and more preferably about 50 wt. % to about 93 wt. % on a dry basis. For example, calcium carbonate as the primary DT filler can preferably be included in a drying-type joint compound at about 65 wt. % to about 93 wt. % on a dry basis. In another example, calcium sulfate dihydrate as the primary DT filler can preferably be included in a drying-type joint compound at about 50 wt. % to about 93 wt. % on a dry basis, and more preferably at about 55 wt. % to about 75 wt. % on a dry basis.

Examples of secondary DT fillers include, but are not limited to, glass micro bubbles, mica, perlite, pyrophyllite, silica, calcium sulfate anhydrite, diatomaceous earth, clay (e.g., attapulgite, sepiolite and kaolin), resin microspheres, and mixtures thereof. Secondary DT fillers may be useful as fillers and used to impart specific properties to the joint compounds. For example, mica aids in reduced cracking of the joint compound as it dries, and is preferred in amounts of up to 25 wt. % on a dry basis. It is also preferred to add clay in amounts of up to about 10 wt. % on a dry basis to improve the body and workability of the joint compound, and as a rheology modifier.

For drying-type joint compounds, the secondary DT filler can be included at up to about 25 wt. % on a dry basis of the joint compound, preferably about 3 wt. % to about 25 wt. % on a dry basis, and more preferably about 4 wt. % to about 25 wt. % on a dry basis.

Typically the joint compound has an absence of calcium sulfate hemihydrate. The joint compound may have an absence of calcium sulfate dihydrate or less than 10 wt. % calcium sulfate dihydrate.

Fillers may be useful as fillers and also as functional fillers used to impart specific properties to the joint compounds. For example, mica aids in reduced cracking of the joint compound as it dries, and is preferred in amounts of up to 25 wt. % on a dry basis. It is also preferred to add clay in amounts of up to about 10 wt. % on a dry basis to improve the body and workability of the joint compound, and as a rheology modifier.

The perlite can be uncoated perlite or coated perlite. Coated perlite is perlite coated with a hydrophobic coating, for example, a coating containing siloxane or silane. The perlite can be a mixture of coated perlite and uncoated perlite. Perlite or expanded perlite is a lightweight filler that may be used where the joint compound is preferably lightweight. Use of expanded perlite in a lightweight joint compound is taught in U.S. Pat. No. 4,454,267, which is herein incorporated by reference. Expanded perlite is a very lightweight material that contains many cracks and fissures. The perlite may be treated with a hydrophobic coating, for example a hydrophobic coating of silane or siloxane. For example, the perlite can be treated according to the teachings of U.S. Pat. No. 4,525,388 to Rehder et al, which is hereby incorporated by reference, so that the material does not increase in weight due to water absorbed by capillary action. The treated, expanded perlite, when used, is typically present in concentrations of at least 5 wt. % on a dry basis of the joint compound.

Any joint compound of the present invention optionally includes resin microspheres as a filler to be used in place of or in addition to expanded perlite in lightweight formulations. Preferred shell resins suitable for use in the present invention are homopolymers, copolymers, or blends of homopolymers and/or copolymers formed one or more of acrylonitrile (“ACN”), vinylidene chloride (“VDC”), or methyl methacrylate (“MMA”) monomers. Particularly preferred resins are polyacrylonitrile (“PACN”), polyvinylidene chloride (“PVDC”), copolymers formed from ACN and VDC, and copolymers found from ACN, VDC, and MMA. The microspheres demonstrate high resiliency to compression without collapse (non-friable) and are able to withstand the exerted shear stress (shear-stability) of a typical joint treatment manufacturing process and subsequent customer preparation.

Binders

Any binder that is suitable for use in a joint compound is appropriate for use in the present invention. The binder can enhance the adhesion of the joint compound to its substrate, typically drywall.

Examples of binders include, but are not limited to, polyvinyl acetate, polyvinyl alcohol, ethylene vinyl acetate co-polymer, vinyl chlorides, vinyl acrylic co-polymer, styrene acrylics, styrene butadiene, polyacrylamide, polyvinylacrylic, latex emulsions, natural and synthetic starch, dextrin, casein, and mixtures thereof. There may also be an absence of vinyl acetate.

For drying-type joint compounds, binders can be included up to about 15 wt. %, up to about 8 wt. %, or up to about 4 wt. %.% on a dry basis of the joint compound. For example, at about 1 wt. % to about 15 wt. %, preferably about 1 wt. % to about 10 wt. %, and most preferably about 1 wt. % to about 8 wt. % on a dry basis.

For example, latex emulsion binders are often used in joint compounds and may be included in joint compounds of the invention. Examples include polyvinyl acetate, ethylene vinyl acetate and vinyl acrylic emulsions. The amount used may range from about 1.5 wt. % to about 7 wt. % on a dry basis of the joint compound, preferably about 2 wt. % to about 5.5 wt. % on a dry basis.

The weight ratio of total fillers to total binders is preferably in the range of from about 25:1 to about 5:1, more preferably 15:1 to about 5:1.

The present invention may employ one or more latexes, for example one latex as the sole latex with an absence of additional latex, or a combination of latexes wherein their respective glass transition temperatures may be the same or different. Each of the one or more latexes typically has a glass transition temperature in the range of less than 40° C., or less than 30° C., or less than 20° C., or less than 15° C., or less than 10° C., or less than 0° C., or less than −15° C. Each of the one or more latexes typically has a glass transition temperature of greater than about −100° C., greater than about −80° C., greater than about −40° C., or greater than 10° C., for example about 15° C. to less than 40° C. Compositions of the present invention may include mixtures comprising a first binder and a second. For example, the first binder may comprise a first polymer having a glass transition temperature that is equal to or greater than about −10° C. The second binder may comprise a second polymer having a glass transition temperature in the range of about −80° C. to about 10° C. In the case of these two binders the glass transition temperature of the first binder is at least about 5° C. greater than the glass transition temperature of the second binder, and the first and second polymers have the same chemistry. The glass transition temperature may be measured by any typical method. The resulting glass transition temperature of each test method is within plus or minus 5° C. The most common tests are differential scanning calorimeter (DSC), or dynamic mechanical analyzer (DMA). See for example, ASTM D6604-00 Standard Practice of Glass Transition Temperatures of Hydrocarbon Method by DSC.

Polymeric Thickeners

Polymeric thickeners are added to the joint compound of the present invention. After water is added to the composition, the thickener becomes hydrated and swells, thereby thickening the joint compound. Thickeners are useful, for example, in helping to create the body and flow properties commonly associated with joint compounds. Preferably, the thickener is selected so that it substantially hydrates during the mixing process after water is added to the composition, with little or no hydration of the thickener occurring after mixing is completed, to prevent formation of lumps in the joint compound.

Examples of polymeric thickeners include, but are not limited to, ethylhydroxy ethylcellulose, hydroxypropyl methylcellulose, methylhydroxypropyl cellulose, hydroxyethyl cellulose, cellulose-based gums (e.g., xanthan gum, gum Arabic, alginate, pectin, and guar gums), and mixtures thereof.

For drying-type joint compounds, polymer thickeners can be included at about 0.05 wt. % to about 3 wt. % on a dry basis of the joint compound, preferably about 0.1 wt. % to about 3 wt. % on a dry basis, more preferably about 0.1 wt. % to about 2 wt. % on a dry basis, and most preferably about 0.5 wt. % to about 2 wt. % on a dry basis.

Other Additives

Other additives that can optionally be included in joint compounds include, but are not limited to, rheology modifier, preservatives, biocides, scents, wetting agents, acid-base indicators, fungicides, bactericides, dyes, pigments, defoaming agents, glycols, humectants, dedusting agents, and mixtures thereof. Other additives can be included at up to about 10 wt. % on a dry basis of the joint compound, and preferably about 0.1 wt. % to about 10 wt. % on a dry basis.

Other additives that can optionally be included in joint compounds include, but are not limited to, rheology modifiers which can include surfactants, thickeners, dispersing aids, and/or dedusting agents, such as a wax, oil, and/or polyethylene glycol. The plasticizers and the additional dedusting agents may act together to lower airborne dust generation during sanding. When included, the amount of wax, oil and/or polyethylene glycol used in a joint compound of the invention is preferably in a range of about 0.1 wt. % to about 1 wt. %, more preferably 0.1 wt. % to 0.5 wt. % on a dry basis of the joint compound.

Defoamers reduce or hinder the formation of air bubbles, which may form especially when mixing. Examples of defoamers include, but are not limited to, hydrocarbon-based, silicon-based defoamer, and mixtures thereof.

A glycol can be used in a joint compound to provide functional properties to the joint compound such as wet edge, open time, controlling drying time, and freeze/thaw stability. Examples of glycols include, but are not limited to, diethyl glycol, ethylene glycol, propylene glycol, and mixtures thereof. When included, the amount of glycol used in a joint compound of the invention is preferably in a range of about 0.1 wt. % to about 1 wt. % or 0.1 wt. % to 0.5 wt. % or 0.1 wt. % to 0.25 wt. % on a dry basis of the joint compound.

Methods

The joint compounds described herein can be applied to a surface (e.g., a gypsum board) and allowed to dry and/or set. The dried/set joint compound can then be dry sanded, or wet sanded or sponged. Alternatively, because the joint compounds described herein have improved smoothness when dried/set, the joint compounds can be wet sanded after drying and/or setting.

Dry sanding is generally done by rubbing with dry sandpaper, optionally with a vacuum attachment (e.g., using a drywall vacuum sander). Wet sandpaper is done for example by rubbing with wet sandpaper. Sponging is rubbing the applied joint compound with a sponge wetted with water to be damp. One or more of these can be performed with a vacuum attachment (e.g., using a drywall vacuum sander) to collect any dust formed. Alternatively or additionally, one or more of these methods can be performed in a negative pressure enclosure (e.g., a plastic enclosure with a fan to create negative pressure in the enclosure).

### EXAMPLES

In the examples herein, as mentioned above, percentages of compositions or product formulae are in weight percentages, unless otherwise expressly stated. The reported measurements also in approximate amounts unless expressly stated, for example, approximate percentages, weights, temperatures, distances or other properties.

### Example 1

Ready-mixed joint compounds were produced according to Table 2. The dosing levels of the pH buffer systems are shown in Table 3. The control formulation (DCpH1) had no pH buffer system. DCpH5 had only lime added to boost the pH as is typical in the industry and is for comparison.

TABLE 2

| Compound | Kg |
|---|---|
| Calcium Carbonate | 865 |
| Clay | 39.3 |
| Perlite | 133 |
| Hydroxy Ethyl Cellulose | 6.4 |
| Sodium Nitrite | 0.8 |
| Starch | 5 |
| Polyvinyl Alcohol | 5 |
| Hydroxy propyl methyl cellulose | 2.2 |
| Bleach Solution | 1.5 |
| Latex | 48.4 |
| Preservative | 4.4 |
| Plasticizer | 4.35 |
| PEG 750 | 26.22 |
| Water | 968.5 |
| Total | 2110.07 |

TABLE 3
Dosing Level for Buffer

| | DC pH 1 | | | | |
|---|---|---|---|---|---|
| | (Control) | DC pH 2 | DC pH 3 | DC pH 4 | DC pH 5 |
| Compound (g) (at | 511.23 | 497.6 | 520.9 | 503.37 | 505.17 |
| about 50% solids) | | | | | |
| Na₂CO₃*10H₂O (g) | 0 | 1.74 | 3.48 | 5.13 | 0 |
| NaHCO₃ (g) | 0 | 0.36 | 0.69 | 0.99 | 0 |
| Lime (g) | 0 | 0 | 0 | 0 | 1.25 |

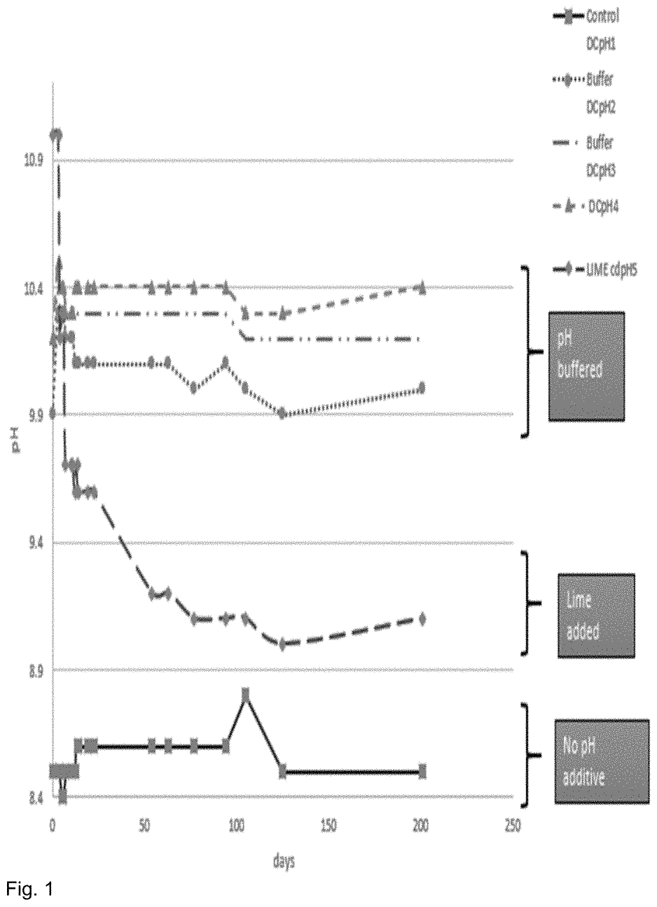

DC pH 2, DC pH3, and DC pH4 had the pH buffer system (Na₂CO₃*10H₂O and NaHCO₃) as shown in FIG. 1, maintained its pH over time, unlike the control with no pH buffer system and the formulation with lime. The storage conditions were 75° F. in a sealed container.

Table 4 reflects the values in FIG. 1.

TABLE 4
pH of Joint Compounds

| Days | DCpH 1 | DCpH 2 | DCpH 3 | DCpH 4 | DCpH 5 |
|---|---|---|---|---|---|
| 0 | 8.5 | 9.9 | 10.1 | 10.2 | 11.0 |
| 3 | 8.5 | 10.3 | 10.4 | 10.5 | 11.0 |
| 4 | 8.5 | 10.3 | 10.4 | 10.4 | 10.2 |
| 5 | 8.4 | 10.3 | 10.4 | 10.4 | 10.3 |
| 6 | 8.4 | 10.3 | 10.4 | 10.4 | 10.3 |
| 7 | 8.5 | 10.2 | 10.3 | 10.3 | 9.7 |
| 10 | 8.5 | 10.2 | 10.3 | 10.3 | 9.7 |
| 11 | 8.5 | 10.2 | 10.3 | 10.3 | 9.7 |
| 12 | 8.5 | 10.1 | 10.3 | 10.4 | 9.6 |
| 13 | 8.6 | 10.1 | 10.3 | 10.4 | 9.7 |
| 14 | 8.6 | 10.1 | 10.3 | 10.4 | 9.6 |
| 19 | 8.6 | 10.1 | 10.3 | 10.4 | 9.6 |
| 22 | 8.6 | 10.1 | 10.3 | 10.4 | 9.6 |
| 54 | 8.6 | 10.1 | 10.3 | 10.4 | 9.2 |
| 63 | 8.6 | 10.1 | 10.3 | 10.4 | 9.2 |
| 77 | 8.6 | 10 | 10.3 | 10.3 | 9.1 |
| 94 | 8.6 | 10.1 | 10.3 | 10.4 | 9.1 |
| 105 | 8.8 | 10 | 10.2 | 10.3 | 9.1 |
| 125 | 8.5 | 9.9 | 10.2 | 10.3 | 9 |
| 201 | 8.5 | 10.0 | 10.3 | 10.4 | 9.1 |

### Example 2

Ready-mixed joint compounds were produced with the amount of preservatives varied for comparison in bacterial and fungal resistance tests.

B292, B345, B348, B373, B376, B389, and B 392 had 100% of the typical amount of triazine for a joint compound with an initial pH of 10.1. B293, B343, B346, B371, B374, B387 and B390 had 50% of the typical amount of triazine for a joint compound with an initial pH of 10.1. B294, B344, B347, B372, B375, B388 and B391 B 375 had 75% of the typical amount of triazine for a joint compound with an initial pH of 10.2.

To evaluate the microbial state of the samples, swabs of each well-mixed sample were applied to potato dextrose agar (PDA) and tryptic soy agar (TSA). PDA plates were incubated at 22 C for 5-7 days, while TSA plates were incubated at 35 C for at 48 hours. After incubation, the degree of contamination along the streak lines was visually estimated for coverage and reported from “0” (no growth) to “4” indicating heavy growth. Growth on PDA and TSA plates was then identified as either bacteria or fungi based on colony morphology and microscopy, where necessary.

The microbial resistance of the samples was determined through bacterial and fungal challenge testing. Wet-state bacterial challenge testing was performed by inoculating the samples with ˜10⁶ CFU/g of a mixed bacterial culture using the following bacterial organisms: Alcaligenes faecalis (ATCC #25094), Enterobacter aerogenes (ATCC #13048), Escherichia coli (ATCC #11229), and Pseudomonas aeruginosa (ATCC #101045). Contamination was monitored at the indicated intervals. Contamination was monitored by streaking the challenged material on TSA plates, incubating, and then rating the growth along the streak liones from “0” (no growth) to “4” (>60% coverage). To evaluate the ability of the formulation to resist repeated challenge, inoculation was repeated in the same manner, as indicated. Results were measured in CFU. “CFU” stands for colony forming unit, as known in the art.

Wet-state fungal challenge testing was performed by inoculating the samples with ˜10⁶ CFU/g of a mixed fungal culture using these fungal organisms: Penicillium polonicum (ATCC #12667), Aspergillus niger (ATCC #6275). Contamination was monitored at the indicated intervals. Contamination was monitored by streaking the challenged material on PDA plates, incubating, and then rating the growth along the streak lines from “0” (no growth) to “4” (>60% coverage). To evaluate the ability of the formulation to resist repeated challenge, inoculation was repeated in the same manner, as indicated.

All samples arrived free of detectable microbial growth and with pH values between 10.1-10.2 The samples all resisted two inoculations with a standard bacteria inoculum. Analytical results showed varying levels of triazine in each sample but within expected levels.

The samples were tested at day 1, 2, and 7 after the microbial challenge over four challenges and no fungal nor bacterial growth was recorded. After the 7 days, the sample was presented with an additional challenge of biological loading and the result is read 48 hours after the re-inoculation (denoted as 48 HR (re) in the tables below.

Material was aged at 50° C. for 2 weeks to simulate long-term aging. Material came in sterile and resisted 2 series of microbial challenge.

TABLE 5
Microbial In-can Preservation Resistance TSA platings
P. aeruginosa, A. faecalis, E. aerogenes, E. coli

| | sterility | 24 hours | 48 hours | 7 days | 48 HR (re) |
|---|---|---|---|---|---|
| ID | Rating | Rating | Rating | Rating | Rating |
| B292 | 0 | 0 | 0 | 0 | 0 |
| B293 | 0 | 0 | 0 | 0 | 0 |
| B294 | 0 | 0 | 0 | 0 | 0 |

TABLE 6
Microbial In-can Preservation Resistance PDA platings
A. niger, Penicillium sp.

| | sterility | 24 hours | 48 hours | 7 days | 48 HR (re) |
|---|---|---|---|---|---|
| ID | Rating | Rating | Rating | Rating | Rating |
| B292 | 0 | 0 | 0 | 0 | 0 |
| B293 | 0 | 0 | 0 | 0 | 0 |
| B294 | 0 | 0 | 0 | 0 | 0 |

TABLE 7
Ratings for Tables 5, 6, and 8-13

| Rating | Average Colonies |
|---|---|
| 0 | 0 |
| 1 | <10 |
| 2 | 11-39 |
| 3 | 40-100 |
| 4 | >100 |

TABLE 8
Microbial In-can Preservation Resistance TSA platings
P. aeruginosa, A. faecalis, E. aerogenes, E. coli

| | sterility | 24 hours | 48 hours | 7 days | 48 HR (re) |
|---|---|---|---|---|---|
| ID | Rating | Rating | Rating | Rating | Rating |
| B343 | 0 | 0 | 0 | 0 | 0 |
| B344 | 0 | 0 | 0 | 0 | 0 |
| B345 | 0 | 0 | 0 | 0 | 0 |
| B346 | 0 | 0 | 0 | 0 | 0 |
| B347 | 0 | 0 | 0 | 0 | 0 |
| B348 | 0 | 0 | 0 | 0 | 0 |

TABLE 9
Microbial In-can Preservation Resistance PDA platings
A. niger, Penicillium sp.

| | sterility | 24 hours | 48 hours | 7 days | 48 HR (re) |
|---|---|---|---|---|---|
| ID | Rating | Rating | Rating | Rating | Rating |
| B343 | 0 | 0 | 0 | 0 | 0 |
| B344 | 0 | 0 | 0 | 0 | 0 |
| B345 | 0 | 0 | 0 | 0 | 0 |
| B346 | 0 | 0 | 0 | 0 | 0 |
| B347 | 0 | 0 | 0 | 0 | 0 |
| B348 | 0 | 0 | 0 | 0 | 0 |

TABLE 10
Microbial In-can Preservation Resistance TSA platings
P. aeruginosa, A. faecalis, E. aerogenes, E. coli

| | sterility | 24 hours | 48 hours | 7 days | 48 HR (re) |
|---|---|---|---|---|---|
| ID | Rating | Rating | Rating | Rating | Rating |
| B371 | 0 | 0 | 0 | 0 | 0 |
| B372 | 0 | 0 | 0 | 0 | 0 |
| B373 | 0 | 0 | 0 | 0 | 0 |
| B374 | 0 | 0 | 0 | 0 | 0 |
| B375 | 0 | 0 | 0 | 0 | 0 |
| B376 | 0 | 0 | 0 | 0 | 0 |

TABLE 11
Microbial In-can Preservation Resistance PDA platings
A. niger, Penicillium sp.

| | sterility | 24 hours | 48 hours | 7 days | 48 HR (re) |
|---|---|---|---|---|---|
| ID | Rating | Rating | Rating | Rating | Rating |
| B371 | 0 | 0 | 0 | 0 | 0 |
| B372 | 0 | 0 | 0 | 0 | 0 |
| B373 | 0 | 0 | 0 | 0 | 0 |
| B374 | 0 | 0 | 0 | 0 | 0 |
| B375 | 0 | 0 | 0 | 0 | 0 |
| B376 | 0 | 0 | 0 | 0 | 0 |

TABLE 12
Microbial In-can Resistance TSA platings
P. aeruginosa, A. faecalis, E. aerogenes, E. coli

| | sterility | 24 hours | 48 hours | 7 days | 48 HR (re) |
|---|---|---|---|---|---|
| ID | Rating | Rating | Rating | Rating | Rating |
| B387 | 0 | 0 | 0 | 0 | 0 |
| B388 | 0 | 0 | 0 | 0 | 0 |
| B389 | 0 | 0 | 0 | 0 | 0 |
| B390 | 0 | 0 | 0 | 0 | 0 |
| B391 | 0 | 0 | 0 | 0 | 0 |
| B392 | 0 | 0 | 0 | 0 | 0 |

TABLE 13
Microbial In-can Preservation Resistance PDA platings
A. niger, Penicillium sp.

| | sterility | 24 hours | 48 hours | 7 days | 48 HR (re) |
|---|---|---|---|---|---|
| ID | Rating | Rating | Rating | Rating | Rating |
| B387 | 0 | 0 | 0 | 0 | 0 |
| B388 | 0 | 0 | 0 | 0 | 0 |
| B389 | 0 | 0 | 0 | 0 | 0 |
| B390 | 0 | 0 | 0 | 0 | 0 |
| B391 | 0 | 0 | 0 | 0 | 0 |
| B392 | 0 | 0 | 0 | 0 | 0 |

Clauses Describing Various Characteristics of Compositions and Methods of the Invention

Clause 1. A ready-mixed, drying-type joint compound comprising a mixture of joint compound components and water;

the joint compound components comprising:

a filler at about 50 wt. % to about 98 wt. % of the joint compound on a dry basis,

a binder at up to about 15 wt. % of the joint compound on a dry basis;

a polymeric thickener at up to about 3 wt. % of the joint compound on a dry basis;

a pH buffer system comprising a weak acid and a conjugate base of the weak acid, at about 0.01 wt. % to about 1.0 wt. %, at about 0.01 wt. % to about 0.25 wt. %, at about 0.025 wt. % to about 0.5 wt. %, at about 0.025 to about 0.15 wt. %, at about 0.05 wt. % to about 0.25 wt. %, at about 0.05 wt. % to about 0.15 wt. %, at about 0.05 wt. % to about 0.10 wt. % of the joint compound on a dry basis; and

an additive up to about 10 wt. % of the joint compound on a dry basis, wherein optionally the additive comprises an accelerator and/or a rheology modifier;

wherein weight ratio of the water to the dry joint compound components is about 1:6 to about 3:1,

wherein at least one of the joint compound components is alkali sensitive.

Clause 2. The joint compound of clause 1, wherein the pH buffer system comprises sodium carbonate and sodium bicarbonate.

Clause 3. The joint compound of clause 1, wherein the pH buffer system comprises K₂HPO₄ and K₃PO₄.

Clause 4. The joint compound of any of the preceding clauses, wherein the pH is 9-11.

Clause 5. The joint compound of clause 1, wherein the pH buffer system comprises ammonia and ammonia chloride.

Clause 6. The joint compound of any of the preceding clauses, wherein the alkali sensitive component comprises one or more of the rheology modifier, the binder, and the additive.

Clause 7. The joint compound of clause 6, wherein the alkali sensitive component comprises the rheology modifier.

Clause 8. The joint compound of clause 6, wherein the alkali sensitive component comprises the binder.

Clause 9. The joint compound of clause 6, wherein the alkali sensitive component comprises the additive.

Clause 10. The joint compound of any of the preceding clauses, wherein:

the filler is at about 50 wt. % to about 93 wt. % of the joint compound on a dry basis;

the binder is up to about 8 wt. % of the joint compound on a dry basis;

the polymeric thickener is up to about 2 wt. % of the joint compound on a dry basis;

the pH buffer system is at about 0.025 wt. to about 0.15 wt. % of the joint compound on a dry basis; and

the additive is up to about 10 wt. % of the joint compound on a dry basis wherein optionally the additive comprises an accelerator and/or a rheology modifier;

wherein the weight ratio of the water to the dry joint compound components about 1:6 to about 3:1.

Clause 11. The joint compound of clause 10, wherein:

the filler is at about 65 wt. % to about 93 wt. % of the joint compound on a dry basis;

the binder is up to about 4 wt. % of the joint compound on a dry basis;

the polymeric thickener is about 0.1 wt. % to about 2 wt. % of the joint compound on a dry basis;

the pH buffer system is at about 0.05 wt. to about 0.10 wt. % of the joint compound on a dry basis;

the additive is about 0.1 wt. % to about 10 wt. % of the joint compound on a dry basis, wherein optionally the additive comprises an accelerator and/or a rheology modifier; and

wherein the weight ratio of the water to the dry joint compound components is about 1:3 to about 1:1.

Clause 12. The joint compound of any of the preceding clauses, wherein the filler comprises calcium carbonate, calcium sulfate dihydrate, talc, glass micro bubbles, mica, perlite, pyrophyllite, silica, calcium sulfate anhydrite, diatomaceous earth, clay, resin microspheres, or mixtures thereof.

Clause 13. The joint compound of any of clauses 1 to 12, wherein the joint compound has a pH of 8-12, preferably 9-11, for 120 days or more at 75° F. (23.9° C.) in a sealed container.

Clause 14. The joint compound of any of the preceding clauses, further comprising up to 0.1 wt. % biocide.

Clause 15. The joint compound of any of the preceding clauses, comprising:

Calcium carbonate,

Clay,

Perlite,

Hydroxyl ethylcellulose,

Sodium nitrite,

Starch,

Polyvinyl alcohol,

hydroxyl propyl methyl cellulose,

Bleach solution,

latex,

preservative,

plasticizer,

PEG 750,

Water and

the pH buffer system.

Clause 16. The joint compound of clause 15, wherein the pH buffer system comprises Na₂CO₃*10H₂O and NaHCO₃.

Clause 17. A method of using the joint compound of any of clauses 1 to 16, comprising applying the joint compound to one or more of the group consisting of boards, joint tape, and another layer of the joint compound.

Clause 18. A method of making the joint compound of any of clauses 1 to 16, comprising combining the at least one filler, the binder, the polymeric thickener, the pH buffer system, and the additive.

While particular versions of the invention have been shown and described, it will be appreciated by those skilled in the art that changes and modifications may be made thereto without departing from the invention in its broader aspects and as set forth in the following claims.

1. A ready-mixed, drying-type joint compound comprising a mixture of joint compound components and water;
the joint compound components comprising:
a filler at about 50 wt. % to about 98 wt. % of the joint compound on a dry basis,
a binder at up to about 15 wt. % of the joint compound on a dry basis;
a polymeric thickener at up to about 3 wt. % of the joint compound on a dry basis;
a pH buffer system comprising a weak acid and a conjugate base of the weak acid, at about 0.01 wt. % to about 1.0 wt. % of the joint compound on a dry basis; and
an additive up to about 10 wt. % of the joint compound on a dry basis, wherein optionally the additive comprises an accelerator and/or a rheology modifier;
wherein weight ratio of the water to the dry joint compound components is about 1:6 to about 3:1,
wherein at least one of the joint compound components is alkali sensitive.

2. The joint compound of claim 1, wherein the pH buffer system comprises sodium carbonate and sodium bicarbonate.

3. The joint compound of claim 1, wherein the pH buffer system comprises K₂HPO₄ and K₃PO₄.

4. The joint compound of claim 1, wherein the pH is 9-11.

5. The joint compound of claim 1, wherein the pH buffer system comprises ammonia and ammonia chloride.

6. The joint compound of claim 1, wherein the alkali sensitive component comprises one or more of the rheology modifier, the binder, and the additive.

7. The joint compound of claim 1, wherein the alkali sensitive component comprises the rheology modifier.

8. The joint compound of claim 1, wherein the alkali sensitive component comprises the binder.

9. The joint compound of claim 1, wherein the alkali sensitive component comprises the additive.

10. The joint compound of claim 1, wherein:
the filler is at about 50 wt. % to about 93 wt. % of the joint compound on a dry basis;
the binder is up to about 8 wt. % of the joint compound on a dry basis;
the polymeric thickener is up to about 2 wt. % of the joint compound on a dry basis;
the pH buffer system is at about 0.025 wt. to about 0.15 wt. % of the joint compound on a dry basis; and
the additive is up to about 10 wt. % of the joint compound on a dry basis wherein optionally the additive comprises an accelerator and/or a rheology modifier;
wherein the weight ratio of the water to the dry joint compound components about 1:6 to about 3:1.

11. The joint compound of claim 1, wherein:
the filler is at about 65 wt. % to about 93 wt. % of the joint compound on a dry basis;
the binder is up to about 4 wt. % of the joint compound on a dry basis;
the polymeric thickener is about 0.1 wt. % to about 2 wt. % of the joint compound on a dry basis;
the pH buffer system is at about 0.05 wt. to about 0.10 wt. % of the joint compound on a dry basis;
the additive is about 0.1 wt. % to about 10 wt. % of the joint compound on a dry basis, wherein optionally the additive comprises an accelerator and/or a rheology modifier; and
wherein the weight ratio of the water to the dry joint compound components is about 1:3 to about 1:1.

12. The joint compound of claim 1, wherein the filler comprises calcium carbonate, calcium sulfate dihydrate, talc, glass micro bubbles, mica, perlite, pyrophyllite, silica, calcium sulfate anhydrite, diatomaceous earth, clay, resin microspheres, or mixtures thereof.

13. The joint compound of claim 1, wherein the joint compound has a pH of 8-12 for 120 days or more at 75° F. (23.9° C.) in a sealed container.

14. The joint compound of claim 1, further comprising up to 0.1 wt. % biocide.

15. The joint compound of claim 1, comprising:
Calcium carbonate,
Clay,
Perlite,
Hydroxyl ethylcellulose,
Sodium nitrite,
Starch,
Polyvinyl alcohol,
hydroxyl propyl methyl cellulose,
Bleach solution,
latex,
preservative,
plasticizer,
PEG 750,
Water and
the pH buffer system.

16. The joint compound of claim 15, wherein the pH buffer system comprises Na₂CO₃*10H₂O and NaHCO₃.

17. The joint compound of claim 1, wherein the pH buffer system is at about 0.01 wt. % to about 0.25 wt. % of the joint compound on a dry basis.

18. The joint compound of claim 1, wherein the pH buffer system is at about 0.025 wt. % to about 0.5 wt. % of the joint compound on a dry basis.

19. A method of using the joint compound of claim 1, comprising applying the joint compound to one or more of the group consisting of boards, joint tape, and another layer of the joint compound.

20. A method of making the joint compound of claim 1, comprising combining the at least one filler, the binder, the polymeric thickener, the pH buffer system, and the additive.
